(19) United States
(12) Patent Application Publication
(10) Pub. No.: US 2013/0121304 A1
(43) Pub. Date: May 16, 2013

(54) ACKNOWLEDGEMENT SIGNALING IN WIRELESS COMMUNICATION NETWORK

(71) Applicant: MOTOROLA MOBILITY LLC, Libertyville, IL (US)

(72) Inventors: Ravikiran Nory, Buffalo Grove, IL (US); Robert T. Love, Barrington, IL (US); Vijay Nangia, Algonquin, IL (US); Ajit Nimbalker, Buffalo Grove, IL (US)

(73) Assignee: MOTOROLA MOBILITY LLC, Libertyville, IL (US)

(21) Appl. No.: 13/662,835

(22) Filed: Oct. 29, 2012

Related U.S. Application Data
(60) Provisional application No. 61/559,039, filed on Nov. 11, 2011.

(51) Int. Cl. H04W 72/04

(52) U.S. Cl. 370/330; 370/329

(57) ABSTRACT

A wireless communication device is disclosed. The device includes a transceiver coupled to a processor configured to determine an antenna port associated with a received control message scheduling a transport block, to determine an acknowledgement resource based on the antenna port, and to cause the transceiver to transmit an acknowledgement on the acknowledgement resource, wherein the acknowledgement indicates receipt or non-receipt of the transport block.

### CROSS-REFERENCE TO RELATED APPLICATIONS

The present application claims benefits under 35 U.S.C. 119(e) to copending U.S. Provisional Application No. 61/559,039 filed on 11 Nov. 2011, the contents of which are incorporated herein by reference.

### FIELD OF THE DISCLOSURE

The present disclosure relates generally to wireless communications and, more particularly, to acknowledgement signaling for Enhanced Control Channel based resource assignments.

### BACKGROUND

In the Third Generation Partnership Project (3GPP) Long Term Evolution (LTE) Releases 8/9/10, a User Equipment (UE) sends a Hybrid Automatic Repeat Request Acknowledgement (HARQ-ACK) in the uplink (UL) corresponding to each Transport Block (TB) received in a downlink (DL) subframe. If x TBs are received by the UE in subframe n then HARQ-ACK signaling corresponding to those x TBs is sent in subframe n+4 (assuming FDD, for TDD the timing depends on specific TDD UL/DL configuration and sent on an >=n+4 UL subframe). The UE sends a HARQ-ACK using either the Physical Uplink Control Channel (PUCCH) or the Physical Uplink Shared Channel (PUSCH). The UE receives TBs on a Physical Downlink Shared Channel (PDSCH). For the UE to send HARQ-ACK on the PUCCH, the UE must first determine PUCCH resources within an uplink subframe on which the HARQ-ACK is transmitted. A PUCCH resource generally comprises a set of time-frequency resources in a subframe with an associated time and/or frequency and/or space spreading code. The PUCCH resource may correspond to one or more transmit antenna port with different antenna ports transmitting on the same or different PUCCH resources. The PUCCH resources (or PUCCH HARQ-ACK resources) that the UE can use to acknowledge a downlink TB, depends on how the downlink TB is assigned or scheduled to the UE.

PUCCH resources are determined using the following approaches in LTE Releases 8/9/10. A first approach is based on signaling on the Physical Downlink Control Channel (PDCCH). According to this approach, the eNB sends a higher layer (Radio Resource Configuration (RRC)) message to configure a set of PUCCH resources for the UE to use for HARQ-ACK signaling. DL scheduling messages (i.e., PDCCHs) that schedule TBs have signaling bits in them that identify which resource(s) among the set of configured PUCCH resources that the UE has to use to acknowledge the TB(s) scheduled by those messages. This approach is typically used for acknowledging TBs scheduled using semi-persistent scheduling (SPS) or for cases where multiple TBs are scheduled in the same subframe over multiple component carriers.

A second approach to determining PUCCH resources in LTE Releases 8/9/10 is based on implicit mapping. The UE implicitly determines the PUCCH resource used for HARQ-ACK signaling from the location of the DL scheduling message in the control region of a subframe. DL scheduling messages are sent over the PDCCH. Each DL scheduling message is sent over a set of control channel elements (CCEs). CCEs within the control region are indexed from 0, 1, . . . to Ncce. Each downlink CCE index in subframe ‘n’ is mapped to a unique uplink PUCCH resource in subframe ‘n+4’. A UE receiving a DL scheduling message and successfully decoding it over a set of CCEs in subframe ‘n’, determines the smallest CCE index of the set and transmits HARQ-ACK for the TB scheduled by that message in the PUCCH resource that corresponds to the smallest CCE index. This approach is typically used for acknowledging TBs scheduled using dynamic scheduling and for cases where TB(s) are scheduled to the UE on one or two component carriers.

For LTE Release 11 (Rel-11), the UE is expected to monitor an Enhanced PDCCH (E-PDCCH) in a new control region (E-PDCCH control region) that occupies distinct resources (e.g., time symbols) from the control region used for PDCCH. To receive E-PDCCH in the new region, the UE must perform blind decoding for several E-PDCCH candidates in the new control region. Two options for E-PDCCH control region are shown in FIG. 1. Other variants are also possible. In the first option the E-PDCCH control region spans a set of resource blocks (RBs) only in the first half of the subframe. In the second option, E-PDCCH control region spans a set of RBs in both the first and second halves of the subframe. More generally, the E-PDCCH control region spans multiple sets of time-frequency resources in the subframe (each set can be called an enhanced control channel element or an eCCE) that are not overlapping with the time-symbols of the legacy control region. Each eCCE can correspond to an RB in the E-PDCCH control region. Alternately, an RB in the E-PDCCH control region can comprise multiple eCCEs.

The new DL control signaling (i.e., E-PDCCH) is expected to be used to complement the existing Rel-8/9/10 downlink control channels (i.e., PDCCH) for supporting advanced Rel-11+ features such as Coordinated Multi-point Transmissions (CoMP) and further enhanced MIMO techniques including MU-MIMO. E-PDCCH can allow advanced control channel transmission schemes such as beamformed frequency-selective control transmission, dedicated control transmission to a UE via use of demodulation reference signal (DMRS) and spatially multiplexed control channel transmission such as multi-user MIMO control transmission.

When the UE is scheduled to receive a TB using the E-PDCCH, new mechanisms that help the UE to determine appropriate PUCCH resources for acknowledging the TB are required.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIGS. 1A and 1B illustrate prior art E-PDCCH placement alternatives in a frame structure.

FIG. 2 illustrates a wireless communication system.

FIG. 3 illustrates a schematic block diagram of a wireless communication device.

FIG. 4 illustrates a portion of a radio frame.

FIG. 5 is a process flow diagram.

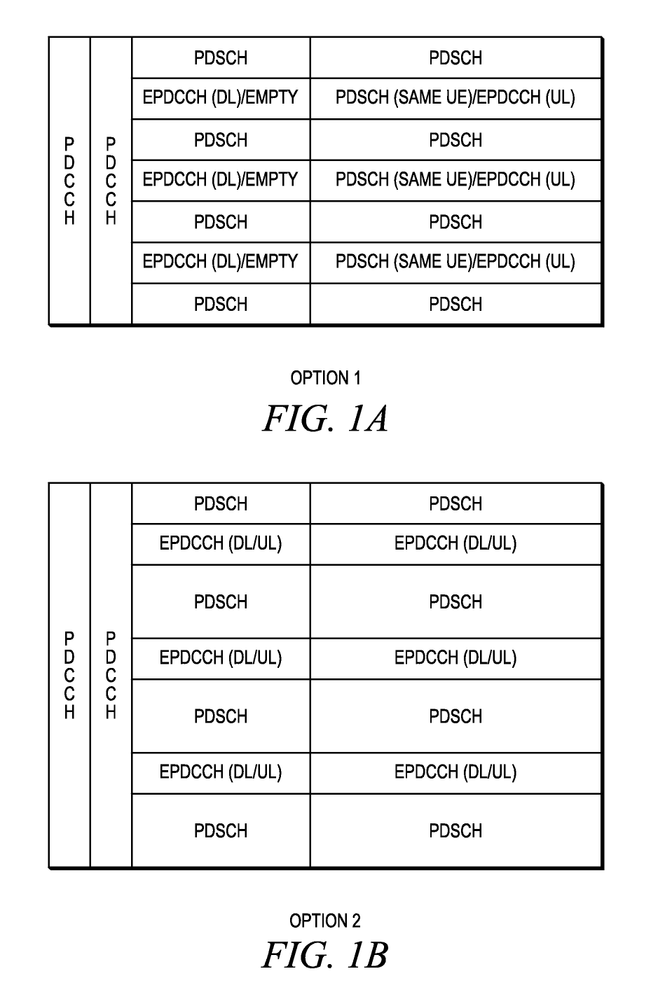

### DETAILED DESCRIPTION

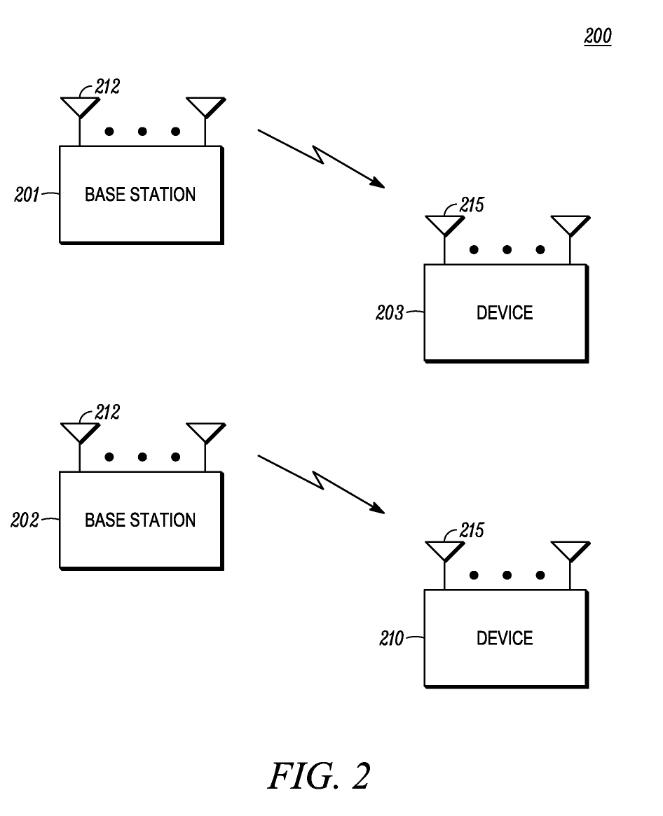

In FIG. 2, a wireless communication system 200 comprises multiple cell serving base units forming a communications network distributed over a geographical region. A base unit may also be referred to as a base station, an access point (AP), access terminal (AT), Node-B (NB), enhanced Node-B (eNB), relay node, home eNB, pico eNB, femto eNB or by other once, present or future terminology used in the art. The one or more base units 201 and 202 serve a number of remote units 203 and 210 within a serving area or cell or within a sector thereof. The remote units may be fixed units or mobile terminals. The remote units may also be referred to as subscriber units, mobile units, users, terminals, subscriber stations, user equipment (UE), user terminals, wireless communication terminal, wireless communication device or by other terminology used in the art. The network base units communicate with remote units to perform functions such as scheduling the transmission and receipt of information using radio resources. The wireless communication network may also comprise management functionality including information routing, admission control, billing, authentication etc., which may be controlled by other network entities. These and other aspects of wireless networks are known generally by those having ordinary skill in the art.

In FIG. 2, base units 201 and 202 transmit downlink communication signals to remote units 203 and 210 on radio resources, which may be in the time, and/or frequency, and/or code and/or spatial domain. The remote units communicate with the one or more base units via uplink communication signals. The one or more base units may comprise one or more transmitters and one or more receivers that serve the remote units. The number of transmitters at the base unit may be related, for example, to the number of transmit antennas 212 at the base unit. When multiple antennas are used to serve each sector to provide various advanced communication modes, for example, adaptive beam-forming, transmit diversity, transmit SDMA, and multiple stream transmission, etc., multiple base units can be deployed. These base units within a sector may be highly integrated and may share various hardware and software components. For example, a base unit may also comprise multiple co-located base units that serve a cell. The remote units may also comprise one or more transmitters and one or more receivers. The number of transmitters may be related, for example, to the number of transmit antennas 215 at the remote unit.

In one implementation, the wireless communication system is compliant with the 3GPP Universal Mobile Telecommunications System (UMTS) Long Term Evolution (LTE) Release-11 protocol, also referred to as EUTRA, wherein the base unit transmits using an orthogonal frequency division multiplexing (OFDM) modulation scheme on the downlink and the user terminals transmit on the uplink PUSCH using a single carrier frequency division multiple access (SC-FDMA) or a Discrete Fourier Transform spread OFDM (DFT-SOFDM) scheme. In another implementation, the wireless communication system is compliant with the 3GPP Universal Mobile Telecommunications System (UMTS) LTE-Advanced protocol, beyond Release 11. More generally the wireless communication system may implement some other open or proprietary communication protocol, for example, WiMAX, among other existing and future protocols. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading.

A UE with multiple receive antennas communicating with a base unit with multiple transmit antennas can support Multiple-Input Multiple-Output (MIMO) communication and can receive data in one or more spatial layers in one or more resource blocks (RBs). The base unit precodes the data to be communicated on one or more spatial layer and maps and transmits the resulting precoded data on one or more antenna ports. The effective channel corresponding to a layer may in general be estimated based on reference signals mapped to one or more antenna ports. In particular, in 3GPP LTE Release 10, demodulation based on DMRS (demodulation RS or UE-specific RS) is supported based on antenna ports numbered as 7-14. An effective channels corresponding to each of the spatial layers 1-8 can be derived based on reference signal transmission on each one of these antenna ports 7-14. This means that a channel corresponding to a spatial layer can be estimated based on the reference signals corresponding to the antenna port associated with the layer. An antenna port is defined such that a channel over which a symbol on the antenna port is conveyed can be inferred from the channel over which another symbol on the same antenna port is conveyed.

More generally, an antenna port can correspond to any well-defined description of a transmission from one or more of antennas. As an example, it could include a beamformed transmission from a set of antennas with appropriate antenna weights being applied, where the set of antennas itself could be unknown to the UE. In this case, the effective channel can be learned from the dedicated reference signal (or the pilot signal) associated with the antenna port. The dedicated reference signal may be beamformed similar to the beamformed data transmission with preferably the same antenna weights being applied to the set of antennas. Typically, the reference signal associated with an antenna port is at least used for channel estimation at the UE. In some particular implementations antenna port can also refer to a physical antenna port at the base unit. A reference signal associated with such an antenna port allows the UE to estimate a channel from the corresponding antenna port to the UE's receivers. Regardless of the actual configuration and weighting of the antennas, for purpose of UE demodulation, the channel estimated based on an antenna port(s) is the channel corresponding to the associated spatial layer. In certain cases, the beamforming or precoding applied at the base unit may be transparent to the UE i.e. the UE need not know what precoding weights are used by the base unit for a particular transmission on the downlink.

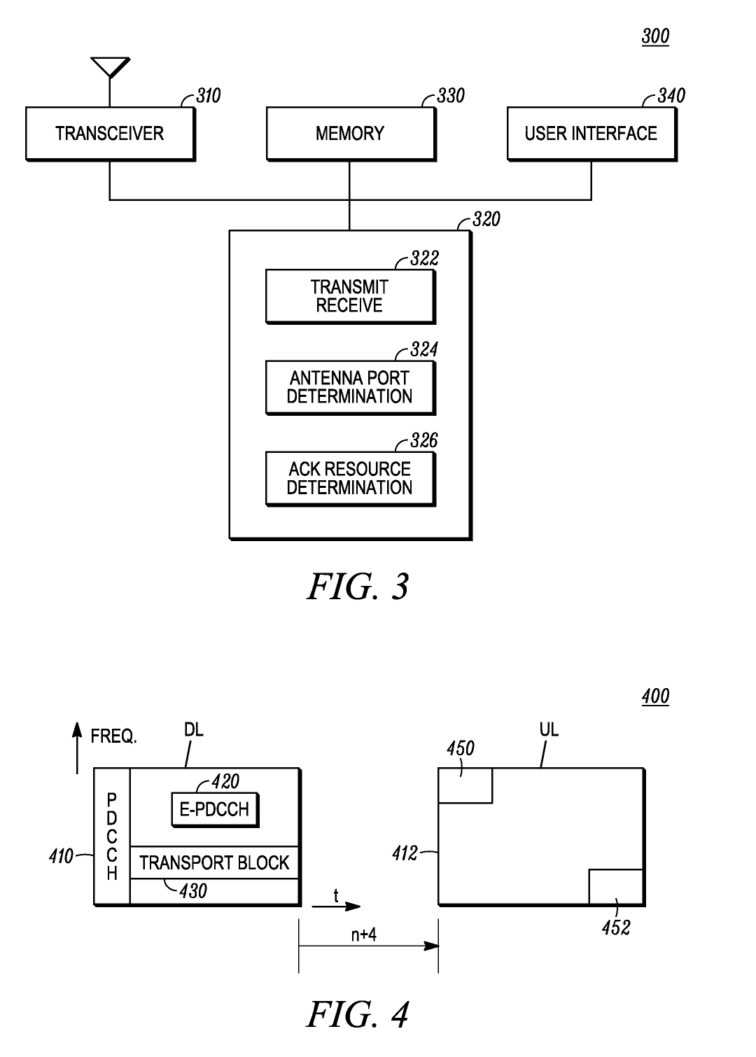

FIG. 3 illustrates a schematic block diagram of a wireless communication device 300 comprising generally a wireless transceiver 310 configured to communicate pursuant to a wireless communication protocol examples of which are discussed. The wireless transceiver 310 is representative of a first transceiver that communicates pursuant to a first wireless communication protocol and possibly one or more other transceivers that communicates pursuant to other corresponding wireless communication protocols. In one embodiment, the first protocol is a cellular communication protocol like 3GPP LTE Rel-11 or some later generation thereof or some other wireless communication protocol, some non-limiting examples of which were provided above. In other embodiments, there is only one wireless transceiver.

In FIG. 3, the transceiver 310 is communicably coupled to a processor 320 that includes functionality 322 that controls the transmission and reception of signals or information by the one or more transceivers. The functionality of the controller is readily implemented as a digital processor that executes instructions or code stored in memory 330, which may be embodied as software stored in a memory device or firmware. Alternatively, this functionality may be performed by equivalent analog circuits or by a combination of analog and digital circuits. When implemented as a user terminal or User Equipment (UE), the device 300 also includes a user interface 340 that typically includes tactile, visual and audio interface elements as is known generally by those having ordinary skill in the art. Other aspects of the terminal 300 that pertain to the instant disclosure are described further below.

According to one aspect of the disclosure, various mechanisms are disclosed for the UE to determine PUCCH resources for acknowledging a transport block (TB). The TB typically contains data payload intended for the UE. In LTE Rel-11, the TB may be scheduled by an eNB for the wireless communication device using the E-PDCCH. It is generally desirable for the determination mechanism to be efficient. In the exemplary LTE Rel-11 implementation, for example, the additional E-PDCCH related PUCCH resource provisioning at the eNB should be minimized. In some, but not necessarily all, implementations backwards compatibility is also desirable. In the LTE Rel-11 implementation, for example, PUCCH performance of legacy UEs, e.g., Rel-8/9/10 UEs, should not be impacted adversely.

In wireless communication systems where Multi-user MIMO (MU-MIMO) is implemented, the mechanism by which the UE determines PUCCH resources for acknowledging a transport block (TB) should also be compatible with MU-MIMO E-PDCCH transmission scenarios. In LTE Rel-11 for example, the UE may monitor two separate E-PDCCH candidates in the same set of time-frequency resources (e.g., resource blocks or control channel elements) where the first candidate is associated with a first antenna port (i.e., the first candidate is decoded or demodulated using reference signals associated with the first antenna port) and the second candidate is associated with a second antenna port (i.e., the second candidate is demodulated using reference signals associated with the second antenna port). Some approaches are described below.

Generally, the base station transmits a control message to the UE scheduling a transport block. FIG. 4 illustrates a sequence of frames 400 including a portion of a downlink (DL) radio frame 410, which may be embodied as a sub-frame, having time and frequency domains or dimensions. The sub-frame 410 comprises a Physical Downlink Control Channel (PDCCH) 410 and an Enhanced Physical Downlink Control Channel (E-PDCCH) 420 with control signaling. The sub-frame also includes a transport block 430. In one embodiment, a control message scheduling the transport block is part of the E-PDCCH. FIG. 4 also shows that the control message and the transport block scheduled by the control message are both within or constitute the same sub-frame and that the control message and the transport block overlap at least partially in the time domain. In another example the control message and the transport block overlap at least partially in the frequency domain. In another example the control message may schedule the transport block in a subframe other than the subframe comprising the control message. The transport block may be scheduled in the same carrier or a different carrier than the control message. In yet another example a subframe may not include a PDCCH but include an E-PDCCH. In such an example, the E-PDCCH may start from the beginning of the subframe or from a predetermined position or time symbol in the subframe.

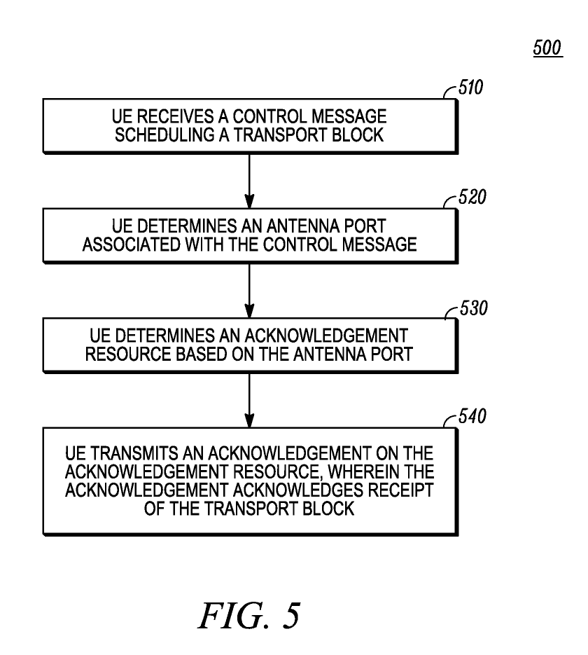

In the process flow diagram of FIG. 5, at 510, the UE receives a control message scheduling a transport block. At 520, the UE determines an antenna port associated with the control message. In one embodiment, the antenna port associated with the control message is determined by determining the antenna port on which the control message was transmitted by the base station. Generally, the processor attempts to decode the control message on a plurality of candidate antenna ports. The antenna port associated with the control message is the antenna port on which the control message is successfully decoded. In one embodiment, a successfully decoded or successfully demodulated control message is a decoded message that passes a cyclic redundancy check (CRC). In some implementations the CRC is masked or scrambled with a radio network temporary identifier (RNTI) or UEID associated with the UE. In some implementations, the UEID or RNTI may be implicitly encoded as a seed to generate a scrambling sequence that is used to scramble the control message. In one particular implementation, the processor estimates a channel on which the control message is received using a reference signal associated with the antenna port and the processor determines the antenna port associated with the control message based on successful decoding of the control message using the channel estimates obtained from the reference signal.

In another implementation, the processor attempts to decode the control message on a plurality of spatial layers with each spatial layer corresponding to particular reference signals of a particular antenna port. The reference signals for different antenna ports may be multiplexing in time, frequency and/or code domain. The effective channel of each spatial layer is estimated by the processor based on the reference signals of the antenna port associated corresponding to that spatial layer. For example, a UE in LTE Rel-11 may attempt to decode a control message received in an E-PDCCH RB or CCE on a spatial layer corresponding to the reference signals of antenna port ‘x’. The UE may also attempt to decode the control message in the same E-PDCCH RB or CCE on another spatial corresponding to the reference signals of antenna port ‘y’. If the UE successfully decodes the control message on the spatial layer corresponding to the reference signals of antenna port ‘x’ it determines that antenna port ‘x’ is associated with the control message and, if the UE successfully decodes the control message on the spatial layer corresponding to the reference signals of antenna port ‘y’ it determines that antenna port ‘y’ is associated with the control message. In this implementation, the reference signals associated with antenna port ‘x’ and ‘y’ can be Demodulation reference signals (DM-RS).

In one example, the UE hypothesizes the antenna port associated with a control message transmission, determines a suitable set of time-frequency and code resource (e.g. resource elements and scrambling sequence used for pilots) to determine an associated reference signal (i.e. pilot) within its received signal, the reference signal is used to perform channel estimation that provides channel estimates and these channel estimates and the received signal are used to generate the Log-Likelihood ratios (LLRs) associated with the control message (assuming a particular message size, encoding parameters such a FEC, modulation, etc). The LLRs are then processed using a FEC decoder (e.g. convolutional code, turbo code, Low-density parity check code, Reed Solomon Code, etc) and/or error checker (e.g. CRC) and if the result indicates correct reception, then the control message is considered to be successfully decoded. If the decoding of current candidate fails, then the process is repeated for next hypothesis (i.e. next potential control channel). In another embodiment the UE determines the PUCCH resource for acknowledging a TB based on the antenna port associated with a successfully decoded control message and the antenna port indicated by the control message for the scheduled TB.

In FIG. 3, the processor 320 includes functionality 324 that determines the antenna port. The antenna port determination functionality is readily implemented by a digital processor that executes instructions or code stored in memory 330, which may be embodied as software stored in a memory device or firmware. Alternatively, this functionality may be performed by equivalent analog circuits or by a combination of analog and digital circuits.

In FIG. 5, at 530, the UE determines an acknowledgement resource based on the antenna port. In LTE, the acknowledgement resource can be a PUCCH resource in an uplink subframe. Various mechanisms for determining the acknowledgement resource are described further below. In FIG. 3, the processor 320 includes functionality 326 that determines the acknowledgement resource. The acknowledgement resource determination functionality is readily implemented by a digital processor that executes instructions or code stored in memory 330, which may be embodied as software stored in a memory device or firmware. Alternatively, this functionality may be performed by equivalent analog circuits or by a combination of analog and digital circuits.

FIG. 4 illustrates the sequence of frames including a portion of an uplink (UL) radio frame 412 having an acknowledgement resource 450 and 452 on which the UE can transmit an acknowledgement acknowledging receipt of the transport block scheduled by the control message. Generally, the acknowledgement can be embodied as a negative acknowledgement (NACK) or a positive acknowledgement (ACK). The term acknowledgement as used herein is used generically to cover both positive acknowledgement and negative acknowledgement and possibly the DTX (Discontinuous transmission). The DTX may be useful is several cases, including, e.g. if the control message is received, but the transport block is lost or if the control message is received but the UE is unable to decode the transport block and wants to feedback that information to the base station or the UE has not successfully decoded the control message. The UE may also multiplex other control information with the acknowledgement information such as channel quality indicator, rank indicator, etc. In some embodiments the acknowledgment resource can be used to acknowledge the receipt of a codeword associated with the transport block. In some other embodiments the acknowledgment resource can be used to acknowledge a plurality of transport blocks or a plurality of codewords associated with the transport block. The plurality of transport blocks may be received in different subframes or different component carriers or a combination thereof.

In FIG. 5, at 540, the UE transmits an acknowledgement on the acknowledgement resource, wherein the acknowledgement indicates receipt or non-receipt of the transport block by the UE or successful or non-successful reception of the transport block by the UE. The transport can be received by the UE in a set of Physical Downlink Shared Channel (PDSCH) resources in the subframe. The UE can determine the set of PDSCH resources (in which the transport block is received) from the control message that scheduled the transport block. As described above, the processor includes functionality that controls the transmission of signals or information including acknowledgements by the transceiver.

In one embodiment, the processor is configured to determine the acknowledgement resource based on a resource block (RB) index of a RB on which the control message is successfully decoded. In another embodiment, the processor is configured to determine the acknowledgement resource based on a resource block (RB) index of a RB and a size of a candidate set of RBs on which the control message is expected to be received. In yet another embodiment, the processor is configured to determine the acknowledgement resource based on a resource block (RB) index of a RB and a sub-frame index of a sub-frame in which the control message is received. In yet another embodiment, the processor is configured to determine the acknowledgement resource based on a resource block (RB) index of a RB and a slot index of a slot within a sub-frame (sub-frame comprising a plurality of slots) in which the control message is received. In still another embodiment, the processor is configured to determine the acknowledgement resource from a set of acknowledgement resources in a configuration message.

In one embodiment, the processor is configured to determine the acknowledgement resource based on an enhanced Control Channel Element (eCCE) index of an eCCE on which the control message is successfully decoded. In another embodiment, the processor is configured to determine the acknowledgement resource based on an eCCE index of an eCCE and a size of a candidate set of eCCEs on which the control message is expected to be received. In yet another embodiment, the processor is configured to determine the acknowledgement resource based on an eCCE index of an eCCE and a sub-frame index of a sub-frame in which the control message is received. In yet another embodiment, the processor is configured to determine the acknowledgement resource based on an eCCE index of an eCCE and a slot index within a sub-frame (sub-frame comprising a plurality of slots) in which the control message is received. In still another embodiment, the processor is configured to determine the acknowledgement resource from a set of acknowledgement resources in a configuration message.

In one particular implementation, the processor is configured to determine the acknowledgement resource based on a single bit or a sequence of bits signaled in the control message. In one embodiment, the eNB pre-configures the UE with multiple PUCCH resources (e.g., 4) via RRC signaling. When scheduling a TB using E-PDCCH in subframe n, eNB sends additional bits (ARI bits) in the E-PDCCH (e.g., 2 bits) that instruct the UE to select a PUCCH resource from the preconfigured PUCCH resources for HARQ-ACK transmission corresponding to the TB in subframe ‘n+x’, where ‘x’ depends on the HARQ feedback timing (e.g. ‘x’=4 for FDD, and is a configuration dependent value for TDD).

The mapping between the ARI bits and PUCCH resources depends on the antenna port based on which the control message in the E-PDCCH is successfully demodulated. For example, the UE may be pre-configured with 8 PUCCH resources h0, h1, . . . h7 via RRC signaling. The UE is further expected to receive 2 ARI bits in E-PDCCH (i.e., the control message in the E-PDCCH). Then, depending on the antenna port on which the UE successfully demodulates E-PDCCH, the UE can determine its PUCCH resource using a mapping rule. One example mapping rule is shown in Table 1 below. With this approach, when MU-MIMO is used for E-PDCCH transmission (E-PDCCH transmission to more than one UE on the same time-frequency resource) and, if two UEs (e.g., UE1 and UE2) successfully demodulate their E-PDCCH control messages on the same set of DL time frequency resources (e.g., UE1 using antenna port 7 and UE2 using antenna port 8 on the same RB or eCCE) the UL PUCCH resources that the UEs require are distinctly identified using only 2 ARI bits. The UEs are unaware of the actual MU-MIMO transmission or in other words the MU-MIMO transmission in transparent to the UE and each UE determines its PUCCH resource based on the signaled ARI bits and the antenna port index used to successfully decode the control message. The ARI bits may be sent individually or jointly coded with other fields in the Downlink Control Information of the control message.

TABLE 1
ARI and E-PDCCH AP mapping to PUCCH resources

| | ARI bits | |
|---|---|---|
| DM-RS Antenna port | signaled | Pre-configured |
| associated with E-PDCCH | via in E- | PUCCH |
| demodulation | PDCCH | resource |
| 7 | 00 | h0 |
| 7 | 01 | h1 |
| 7 | 10 | h2 |
| 7 | 11 | h3 |
| 8 | 00 | h4 |
| 8 | 01 | h5 |
| 8 | 10 | h6 |
| 8 | 11 | h7 |

In some embodiments, the antenna port number or index may be an absolute index such as antenna port 7, 8 or a relative antenna port index such as 0 and 1 such as when two antenna ports can be configured for E-PDCCH. The number of antenna ports configured can be signaled by higher-layers and may be an UE-specific configuration or a configuration common to a plurality of UEs or a cell-common configuration. The UE-specific configuration of the antenna ports for E-PDCCH may be a subset of the cell-common configuration of antenna ports that may be used for E-PDCCH. In some embodiments, the relative antenna port index may be obtained by subtracting a fixed or predetermined or signaled value from the antenna port number or index.

Alternately, the mapping between ARI bits and preconfigured PUCCH resources may also depend on ‘number of antenna ports’ that can be configured for E-PDCCH reception on the same set/subset of resources. Alternately, the UE may be pre-configured with separate sets of PUCCH resources with each set linked to a particular antenna port (one to one mapping or many to one mapping) and, the ARI bits indicated in the E-PDCCH received using a particular antenna port point to a PUCCH resource in the set linked that antenna port.

Note: while the discussion below assumes 1 E-PDCCH CCE (control channel element) per RB, it may be possible that multiple E-PDCCH CCEs can be present in an RB. In such a scenario, n_{RB}^{EPDCCH} used below may be replaced by n_{CCE}^{EPDCCH} (index of eCCE on which E-PDCCH is successfully decoded) and N_{RB}^{EPDCCH} can be replaced by N_{CCE}^{EPDCCH} (total number of eCCEs monitored by the UE in a sub frame).

In one particular implementation, the UE determines the PUCCH resource (n_{PUCCH}^{(e)}) using an implicit mapping based on the RB index (n_{RB}^{EPDCCH}), the antenna port (n_{AP}^{EPDCCH}) on which E-PDCCH (i.e., the control message in the E-PDCCH) was successfully decoded, and using a PUCCH resource offset (n_{offset}), i.e, n_{PUCCH}^{(e)}=f(n_{RB}^{EPDCCH}, n_{AP}^{EPDCCH}, n_{offset}). In some implementations, in place of the RB index the UE may use an eCCE index (n_{CCE}^{EPDCCH}) of the eCCE on which E-PDCCH is successfully decoded.

The resource offset for PUCCH resources (n_{offset}) may be signaled to the UE or determined by the UE in various ways. In one embodiment, n_{offset} is signaled using radio resource control (RRC) signaling. In another embodiment, n_{offset} is indicated to the UE using additional bits in the control message. The additional bits identify an offset value from a set of preconfigured (via RRC) or predefined offset values. In another embodiment, the UE determines n_{offset} based on the Physical Control Format Indicator (PCFICH) value signaled in the sub-frame in which E-PDCCH is received. This allows the UE to implicitly change the starting position of PUCCH resources corresponding to TBs scheduled by E-PDCCH based on the end point of the PUCCH resources corresponding TBs scheduled by PDCCH, i.e., beyond the last PUCCH resource that can be possibly be used for HARQ-ACK feedback corresponding to a TB scheduled by PDCCH. This allows more efficient usage of uplink resources between legacy UEs (or UEs using PDCCH) and UEs that use the enhanced PDCCH. In yet another embodiment the UE determines n_{offset} based on ARI bits in the E-PDCCH. In another embodiment, n_{offset} is indicated to the UE based on a combination of a first portion of bits signaled using radio resource control (RRC) signaling and a second portion of bits indicated to the UE in the control message.

The PUCCH resource (n_{PUCCH}^{(e)}) can be implicitly determined by the UE based on n_{RB}^{EPDCCH} (or n_{CCE}^{EPDCCH}) and n_{AP}^{EPDCCH} using the following options. For the options considered below, n_{AP}^{EPDCCH} may be a mapped or relative Antenna port (AP) index, i.e., if E-PDCCH is decoded based on AP7, n_{AP}^{EPDCCH}=0, if E-PDCCH is decoded based on AP8, n_{AP}^{EPDCCH}=1, . . . ). Note here that AP7 and AP8 corresponds to Antenna Port 7 and Antenna Port 8. In general as described previously, an antenna port may be associated with pilot or reference signals. Thus, given antenna port information, a UE may be able to acquire the location and other information of the associated pilots in the received signal, and further use the acquired pilots to demodulate received signal associated with the antenna port (or the portion of the received signal associated with the antenna port).

According to a first option, the PUCCH resource may be determined based on the following equation: n_{PUCCH}^{(e)}=n_{RB}^{EPDCCH}+N_{RB}^{EPDCCH}×n_{AP}^{EPDCCH}+n_{offset}. In this option, the first value associated with the E-PDCCH region (N_{RB}^{EPDCCH}) can be N_{RB}^{DL} i.e., the total number of resource blocks comprising the downlink channel bandwidth configuration of the UE (full PUCCH resource provisioning without any PUCCH resource related scheduler restrictions). Alternatively, the first value associated with the E-PDCCH region N_{RB}^{EPDCCH} can be a UE specific number of E-PDCCH RBs configured via RRC. In this case the eNB has to signal n_{offset} and N_{RB}^{EPDCCH} on a per UE basis to manage PUCCH resource related scheduler restrictions. In the first option, the PUCCH resource is determined based on a resource block index associated with the E-PDCCH containing the message, a first value associated with the EPDCCH region, a first offset value associated with the PUCCH region, an antenna port value associated with the E-PDCCH on which the message was received. In a slightly different variant of the first option, the PUCCH resource may be determined based on the following equation: n_{PUCCH}^{(e)}=n_{cce}^{EPDCCH}+N_{CCE}^{EPDCCH}×n_{AP}^{EPDCCH}+n_{offset} where, n_{CCE}^{EPDCCH} is an index of an eCCE on which E-PDCCH is successfully decoded and N_{CCE}^{EPDCCH} is the total number of eCCEs monitored by the UE in a sub frame. N_{CCE}^{EPDCCH} can be a UE specific value that is signaled to the UE by an eNB. Alternately, N_{CCE}^{EPDCCH} can be determined by the UE from N_{RB}^{EPDCCH} that is signaled to the UE. According to this variation of the first option, the PUCCH resource is determined based on a eCCE index associated with the E-PDCCH containing the message, a first value associated with the EPDCCH region, a first offset value associated with the PUCCH region, an antenna port value associated with the E-PDCCH on which the message was received.

According to a second option, the PUCCH resource may be determined based on the following equation: n_{PUCCH}^{(e)}=mod((n_{RB}^{EPDCCH}+N_{RB}^{DL}×n_{AP}^{EPDCCH}),X)+n_{offset}. In this option X can be a fixed value or a value signaled to all UEs in the cell via RRC. an interger value smaller than the maximum value corresponding to full PUCCH resource provisioning for the serving cell without any PUCCH resource related scheduler restrictions, for example, N_{RB}^{DL}×N_{AP}^{EPDCCH} where N_{AP}^{EPDCCH} is the number of possible antenna ports for E-PDCCH which may be fixed, pre-determined or configured. Alternatively, if the same n_{offset} is used by all UEs, X is the maximum number of E-PDCCH PUCCH resources configured for that serving cell. In the second option, the PUCCH resource is determined based on a modulo function of a resource block index associated with the E-PDCCH containing the message and/or a first value associated with the E-PDCCH region and/or an antenna port value associated with the E-PDCCH on which the message was received and a maximum number of PUCCH resources, and/or based on a first offset value associated with the PUCCH region. The benefit of this option is that it allows an eNB to control the maximum number of PUCCH resources for use with E-PDCCH. In a slightly different variant of the second option, the PUCCH resource may be determined based on the following equation: n_{PUCCH}^{(e)}=mod((n_{CCE}^{EPDCCH}+N_{CCE}^{EPDCCH}×n_{AP}^{EPDCCH}),X)+n_{offset} where, n_{CCE}^{EPDCCH} is an index of an eCCE on which E-PDCCH is successfully decoded. In this variant of the second option, the PUCCH resource is determined based on a modulo function of a eCCE index associated with the E-PDCCH containing the message and/or a first value associated with the E-PDCCH region and/or an antenna port value associated with the E-PDCCH on which the message was received and a maximum number of PUCCH resources, and/or based on a first offset value associated with the PUCCH region. The first value associated with the E-PDCCH region can be N_{CCE}^{EPDCCH}.

According to a third option, the PUCCH resource may be determined based on the following equation: n_{PUCCH}^{(e)}=n_{RB}^{EPDCCH}+N_{RB}^{EPDCCH}+mod(n_{AP}^{EPDCCH},Y)+n_{offset}. Here, Y is a maximum number of E-PDCCHs that can be spatially multiplexed on the same set of time-frequency resources such as 1 RB or 1CCE. In the third option, the PUCCH resource is determined based on the resource block index associated with the E-PDCCH containing the message and/or a first value associated with the E-PDCCH region, and/or a modulo function of an antenna port value associated with the E-PDCCH on which the message was received and a maximum number of E-PDCCHs supported on the resource block (or the eCCE), and/or a first offset value associated with the PUCCH region. In a slightly different variant of the third option, the PUCCH resource may be determined based on the following equation: n_{PUCCH}^{(e)}=n_{CCE}^{EPDCCH}+N_{CCE}^{EPDCCH}×mod(n_{AP}^{EPDCCH},Y)+n_{offset} where, n_{CCE}^{EPDCCH} is an index of an eCCE on which E-PDCCH is successfully decoded. In the variant of the third option, the PUCCH resource is determined based on the eCCE index associated with the E-PDCCH containing the message and/or a first value associated with the E-PDCCH region, and/or a modulo function of an antenna port value associated with the E-PDCCH on which the message was received and a maximum number of E-PDCCHs supported on the resource block (or the eCCE), and/or a first offset value associated with the PUCCH region. The first value associated with the E-PDCCH region can be N_{CCE}^{EPDCCH}.

According to a fourth option, the PUCCH resource may be determined based on a first offset value (n_{offset1}) that is signaled to the UE by an eNB; a second offset value (n_{offset2}) that is determined by the UE based on one or more of:

a) an identifier of the UE (UEID);

b) the starting RB index (or eCCE index) of the RBs (or eCCEs) on which the E-PDCCH control message is successfully demodulated;

c) the number of RBs monitored by the UE for receiving E-PDCCH (i.e., the candidate set of E-PDCCH RBs);

d) the number of eCCEs monitored by the UE for receiving E-PDCCH (i.e., the candidate set of eCCEs);

e) the subframe index of the UE;

f) the antenna port associated with E-PDCCH detection; and a position (ñ_{RB}^{EPDCCH}) of the RB (or eCCE) on which E-PDCCH control message is successfully demodulated within the E-PDCCH search space. For example, n_{PUCCH}^{(e)}=mod((n_{offset2}+ñ_{RB}^{EPDCCH}+N_{RB}^{EPDCCH}+n_{AP}^{EPDCCH}), X)+n_{offset}. In this option, N_{RB}^{EPDCCH} is the number of RBs in the E-PDCCH search space configured for the UE. n_{offset2} is determined based on one or more of UEID, or the starting RB index (or CCE index) of the RB(s) on which E-PDCCH is demodulated, or the number of RBs in the E-PDCCH search space, and the subframe index and the antenna port associated with E-PDCCH detection ñ_{RB}^{EPDCCH} is determined based on the position of the RB on which E-PDCCH is demodulated within the E-PDCCH search space.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A wireless communication device comprising:
a transceiver coupled to a processor,
the processor configured to determine an antenna port associated with a received control message scheduling a transport block;
the processor configured to determine an acknowledgement resource based on the antenna port;
the processor configured to cause the transceiver to transmit an acknowledgement on the acknowledgement resource, wherein the acknowledgement indicates receipt or non-receipt of the transport block.

2. The device of claim 1, the control message and the transport block constitute a portion of a frame having a time dimension and a frequency dimension, the control message and the transport block overlap at least partially in the time dimension.

3. The device of claim 1, the processor configured to determine the antenna port associated with the control message by successfully decoding the control message on one of a plurality of candidate antenna ports.

4. The device of claim 1, the acknowledgement is a negative acknowledgement (NACK).

5. The device of claim 1, the processor configured to determine the acknowledgement resource based on a resource block (RB) index of a RB on which the control message is successfully decoded.

6. The device of claim 1, the processor configured to determine the acknowledgement resource based on a resource block (RB) index of a RB and a size of a candidate set of RBs on which the control message is expected to be received.

7. The device of claim 1, the processor configured to determine the acknowledgement resource based on a control channel element index of a control channel element in a subframe in which the control message is received.

8. The device of claim 1 the processor configured to determine the acknowledgement resource based on at least one bit signaled in the control message.

9. The device of claim 1, the processor configured to determine the acknowledgement resource from a set of acknowledgement resources in a configuration message.

10. The device of claim 1
the processor configured to estimate a channel on which the control message is received using a reference signal associated with the antenna port, and
the processor configured to determine the antenna port associated with the control message based on the reference signal.

11. The device of claim 1
the processor configured to determine a set of Physical Downlink Shared Channel (PDSCH) resources in a subframe from the control message scheduling the transport block;
the processor configured to cause the transceiver to receive the transport block in the determined set of PDSCH resources.

12. The device of claim 1, the processor configured to determine the antenna port associated with the control message includes determining both the antenna port on which the control message was transmitted and determining the antenna port indicated in the control message associated with a scheduled transport block.

13. A method in a wireless communication device, the method comprising:
receiving a control message scheduling a transport block;
determining an antenna port associated with the control message;
determining an acknowledgement resource based on the antenna port;
transmitting an acknowledgement on the acknowledgement resource, wherein the acknowledgement indicates receipt or non-receipt of the transport block.

14. The method of claim 13 further comprising,
determining a set of Physical Downlink Shared Channel (PDSCH) resources from the control message scheduling the transport block;
receiving the transport block in the determined set of PDSCH resources.

15. The method of claim 13, determining the antenna port associated with the control message by successfully decoding the control message on one of a plurality of candidate antenna ports.

16. The method of claim 13, transmitting an acknowledgement includes transmitting an acknowledgement (ACK) or a negative acknowledgement (NACK).

17. The method of claim 13 further comprising
estimating a channel on which the control message is received using a reference signal associated with the antenna port, and
determining the antenna port associated with the control message based on the reference signal.

18. The method of claim 13 further comprising determining the acknowledgement resource based on a resource block (RB) index of a RB on which the control message is successfully decoded.

19. The method of claim 13 further comprising determining the acknowledgement resource based on a resource block (RB) index of a RB and a size of a candidate set of RBs on which the control message is expected to be received.

20. The method of claim 13 further comprising determining the acknowledgement resource based on a resource block (RB) index of a RB and a subframe index of a subframe in which the control message is received.

21. The method of claim 13 further comprising determining the acknowledgement resource based on at least one bit signaled in the control message.

22. The method of claim 13 further comprising:
receiving a configuration message configuring a set of acknowledgement resources;
determining the acknowledgement resource from the set of acknowledgement resources.

23. The method of claim 13, determining the antenna port associated with the control message includes determining the antenna port on which the control message was transmitted.

24. The method of claim 13, determining the antenna port associated with the control message includes determining both the antenna port on which the control message was transmitted and determining the antenna port indicated in the control message associated with a scheduled transport block.
